(19) United States
(12) Patent Application Publication
(10) Pub. No.: US 2024/0068353 A1
(43) Pub. Date: Feb. 29, 2024

(54) DRILLSTRING WITH ACOUSTIC CALIPER

(71) Applicant: SAUDI ARABIAN OIL COMPANY, Dhahran (SA)

(72) Inventors: Ossama R. Sehsah, Dhahran (SA); Mohammed Khaled Alarfaj, Dhahran (SA)

(73) Assignee: SAUDI ARABIAN OIL COMPANY, Dhahran (SA)

(21) Appl. No.: 17/823,474

(22) Filed: Aug. 30, 2022

(51) Int. Cl. E21B 47/002; E21B 47/09; E21B 47/135; G01V 1/50; G06T 7/00

(52) U.S. Cl. CPC E21B 47/0025; E21B 47/09; E21B 47/135; G01V 1/50; G06T 7/001; E21B 2200/20; E21B 2200/22; G01V 2210/1299; G01V 2210/1429; G01V 2210/74; G06T 2207/30108; G06T 2207/30168

(57) ABSTRACT

A drilling tool for determining a real-time image of a borehole during drilling of the borehole, comprising: a drillstring, an acoustic caliper attached to the drillstring including: an acoustic transmitter that transmits a transmitted acoustic pulse, and an acoustic receiver that receives a reflected acoustic pulse, a well positioning device that determines a depth and accurate position of the acoustic caliper in the borehole, and a Programmable Logic Controller (PLC) that determines, in real-time, the time of flight of the acoustic pulse between transmitting the transmitted acoustic pulse and receiving the reflected acoustic pulse of the acoustic caliper, determines, in real-time, a distance between the acoustic caliper and a borehole wall based on the time of flight, and determines, in real-time, an image of the borehole wall during drilling of the borehole based on the distance as function of the depth and accurate position.

### BACKGROUND

Drilling engineers are responsible for drilling wells safely and economically. Drilling engineers ensure the penetration of the formation, while protecting the health and safety of the drilling personnel and protecting the environment.

Therefore, monitoring a drilling operation is essential for a drilling engineer. The drilling engineer needs to consider as many parameters of the drilling operation as possible to make essential decisions and act in a timely manner. The parameters of the drilling operation are the following.

Non-productive time (NPT) is the time when drilling operations are interrupted and is a measure of the effectiveness of drilling operations. Lag time (LT) is the time taken for cuttings to reach the surface. Health, safety and environmental (HSE) issues are of paramount importance to the drilling and petroleum industry. Adherence to HSE guidelines is a requirement for operators worldwide and is also dictated by internal policies of most corporations.

To avoid NPT, LT, and HSE related catastrophes, measuring the borehole size is an important parameter to make drilling operations more accurate and efficient. However, borehole size measurements are challenging due to high vibration and continuous rotation of the drillstring.

Accordingly, there exists a need for a drilling tool to determine a real-time image of the borehole during drilling of the borehole.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a drilling tool for determining a real-time image of a borehole during drilling of the borehole, comprising: a drillstring that drills a borehole, an acoustic caliper attached to the drillstring, wherein the acoustic caliper comprises: an acoustic transmitter that transmits a transmitted acoustic pulse, and an acoustic receiver that receives a reflected acoustic pulse, wherein the reflected acoustic pulse is a reflection of the transmitted acoustic pulse on a borehole wall, a well positioning device that determines a depth and accurate position of the acoustic caliper in the borehole, and a Programmable Logic Controller (PLC) that determines, in real-time, the time of flight of the acoustic pulse between transmitting the transmitted acoustic pulse and receiving the reflected acoustic pulse of the acoustic caliper, determines, in real-time, a distance between the acoustic caliper and a borehole wall based on the time of flight, and determines, in real-time, an image of the borehole wall during drilling of the borehole based on the distance as function of the depth and accurate position.

In general, in one aspect, embodiments disclosed herein relate to a method for determining a real-time image of a borehole wall during drilling of a borehole, the method being performed during drilling of the borehole and comprising transmitting a transmitted acoustic pulse by an acoustic caliper attached to a drillstring that drills the borehole, receiving a reflected acoustic pulse by the acoustic caliper, wherein the reflected acoustic pulse is a reflection of the transmitted acoustic pulse on the borehole wall, determining a depth of the acoustic caliper in the borehole, determining the time of flight of the acoustic pulse between transmitting the transmitted acoustic pulse and receiving the reflected acoustic pulse, determining a distance between the acoustic caliper and a borehole wall based on the time of flight, and determining an image of the borehole wall during drilling of the borehole based on the distance as function of the depth and an accurate position of the acoustic caliper during drilling of the borehole.

Other aspects and advantages of the claimed subject matter will be apparent from the following description and the appended claims.

### BRIEF DESCRIPTION OF DRAWINGS

FIG. 1 shows a well environment, according to one or more embodiments.

FIG. 2 shows a drillstring with two acoustic calipers, according to one or more embodiments.

FIG. 3 shows a schematic view of the drilling tool, according to one or more embodiments.

FIG. 4 shows a flowchart of the method steps for determining a real-time image of a borehole wall during drilling of a borehole, according to one or more embodiments.

FIG. 5A shows an image of a borehole, according to one or more embodiments.

FIG. 5B shows another image of a borehole, according to one or more embodiments

FIG. 6 shows a computer system, according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments disclosed herein provide real time accurate imaging of a wellbore by utilizing a PLC (Programmable Logic controller) to collect drillstring position from a well positioning device. In one or more embodiments, the well positioning device may be any tool or any combination of tools that may be used for measurement while drilling MWD, Logging while drilling LWD, or gyro while drilling (GWD), collectively.) Further, embodiments disclosed herein collect hole clearance dimensions from two sets of 360 degrees acoustic sensors, and process the received data to develop a 3D image of wellbore and transform this image to the surface. The term surface as used herein refers to a directional operator's cabin of a well environment (i.e., a driller cabin), as opposed to the Earth's surface. Importantly, the 3D image of the wellbore is obtained while drilling and in real-time.

Embodiments of the present disclosure may provide at least one of the following advantages. The drilling tool provides accurate measurements of the borehole geometry by using multiple acoustic receivers. The 3D image is developed by using the distance from the drillstring to the borehole wall (eccentricity) as function of the depth of the borehole.

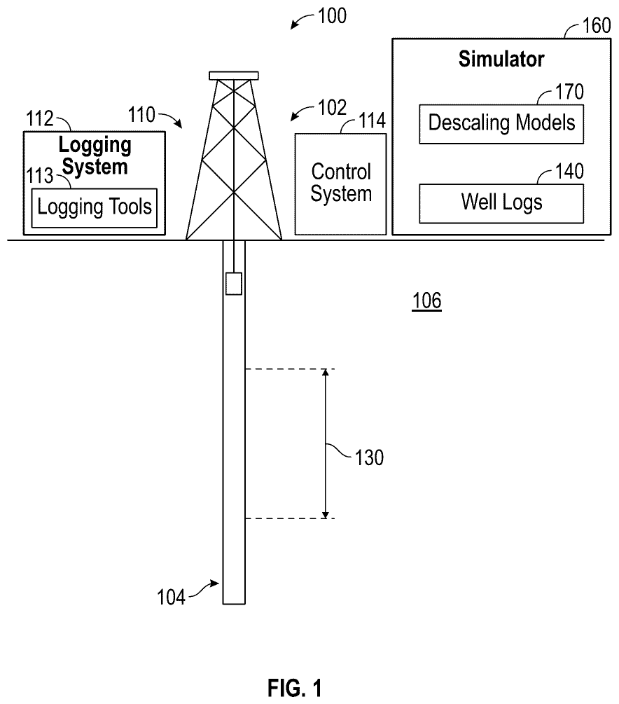

FIG. 1 illustrates a well environment 100 that includes a well 102 having a borehole 104 extending into a formation 106. The borehole 104 is a bored hole that extends from the surface into a target zone of the formation 106, such as a reservoir. The formation 106 may include various formation characteristics of interest, such as formation porosity, formation permeability, resistivity, density, water saturation, and the like. The well environment 100 may include a drilling system 110, a logging system 112, a control system 114, and a simulator 160. The drilling system 110 may include a drillstring, drill bit, a mud circulation system and/or the like for use in boring the borehole 104 into the formation 106.

The control system 114 may include hardware and/or software for managing drilling operations, maintenance operations, and/or well intervention operations. For example, the control system 114 may include one or more programmable logic controllers (PLCs) that include hardware and/or software with functionality to control one or more processes performed by the drilling system 110. Specifically, a PLC may control valve states, fluid levels, pipe pressures, warning alarms, and/or pressure releases throughout a drilling rig. In particular, a PLC may be a ruggedized computer system with functionality to withstand vibrations, extreme temperatures, wet conditions, and/or dusty conditions, for example, around a drilling rig. Thus, controls systems may be used to perform various well operations, such as drilling operations, well completion operations, well intervention operations, and well maintenance operations.

The logging system 112 may include one or more logging tools 113, such as a nuclear magnetic resonance (NMR) logging tool and/or a resistivity logging tool, for use in generating well logs 140 of the formation 106 and/or well components in the borehole 104, such as casings, production tubing, or other well tubulars. For example, a logging tool may be lowered into the borehole 104 to acquire measurements as the tool traverses a depth interval 130 (e.g., a targeted reservoir section) of the borehole 104. The plot of the logging measurements versus depth may be referred to as a “log” or “well log”. Well logs may provide depth measurements of the well 102 that describe such reservoir characteristics as formation porosity, formation permeability, resistivity, density, borehole or tubular sizes, water saturation, and the like. The resulting logging measurements may be stored and/or processed, for example, by the control system 114, to generate corresponding well logs 140 for the well 102. A well log may include, for example, a plot of a logging response time versus true vertical depth (TVD) across the depth interval 130 of the borehole 104.

Furthermore, scales may form within one or more tube sections of the borehole 104. For example, a scale may be a mineral deposit that occurs on borehole tubulars (e.g., casing, production tubulars, etc.) and other well components due to exposure of well fluids, changing temperatures, and different pressure conditions in the production conduit. The formation of scale may affect the performance of downhole tools such as artificial lift equipment. In addition, scales may interfere with the safe operation of pipeline valve systems and rapidly erodes surface chokes because of the high erosion rate when certain chemical compositions flow with a production stream. Thus, scales may result in restrictions, or even a plug, within a borehole tubular and other well equipment. Examples of different scaling types include iron sulfide scaling (e.g., that results in iron sulfide or iron oxide deposits), carbonate scaling (e.g., resulting in calcium carbonate or calcite deposits), sulfate scaling (e.g., resulting in gypsum or anhydrite deposits), silica scaling (e.g., resulting chalcedony or amorphous opal deposits), and/or chloride scaling (e.g., resulting in sodium chloride deposits).

To remove scales, one or more well intervention operations may be performed in the borehole 104. Where iron sulfide scales precipitate in a production well or a water injection well, for example, iron sulfide scales may be removed with a chemical scale treatment, such as a treatment that uses hydrochloric acid in conjunction with sequestering or reducing agents to dissolve the scales. For chemical scale treatments, different solvents may be used depending on the type of scale. In particular, carbonate scales may also be dissolved using hydrochloric acid at specific temperatures, while sulfate scales may be removed using ethylenediamine tetraacetic acid. Chloride scales may be eliminated using fresh water or weak acidic solutions, such as solutions that include acetic acid. Silica scaling that is associated with steam flooding operations may be dissolved with hydrofluoric acid.

Scale treatments may also include mechanical treatments. In some embodiments, for example, coil tubing (CT) milling and high-pressure rotary jetting tools are used to remove scales. Abrasive jetting may cut scales while leaves a corresponding well tubular undamaged. A well intervention operation for a mechanical treatment may use various deployment mechanisms, such as a derrick or a coiled tubing truck to implement a workstring for performing the mechanical treatment within a well. In some embodiments, both chemical and mechanical treatments are used to remove scales (e.g., for iron sulfide scaling, a hydrochloric acid treatment may be used to remove FeS, while a mechanical treatment may be used to remove FeS₂).

Some well intervention operations also include scale-inhibition treatments. More specifically, a scale-inhibition treatment may include applying a chemical inhibitor into a water-producing zone for subsequent commingling with produced fluids, thereby preventing scale precipitation. Scale inhibitors may include various chemicals that delay, reduce and/or prevent scale deposition, such as acrylic acid polymers, maleic acid polymers, and phosphonates. In some embodiments, scale-inhibition treatments are performed using continuous injection into a borehole via a tubing string that may reach various well perforations or injection into a gas lift system. Likewise, a scale inhibitor may be disposed in a rathole (i.e., an additional hole drilled at the end of the well beyond a final zone of interest) to implement a slow dissolution of the scale inhibitor.

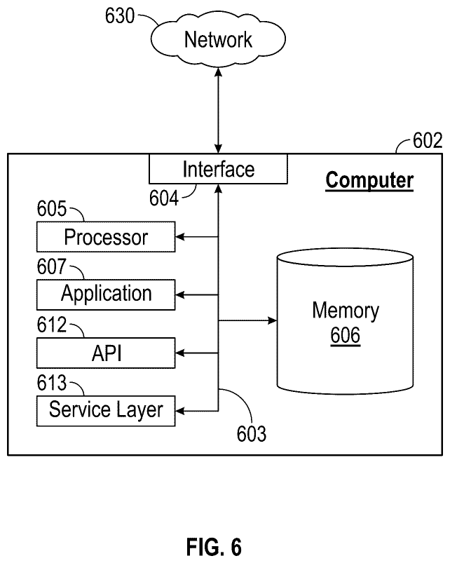

Turning to simulator 160, a simulator 160 may include hardware and/or software with functionality for storing and analyzing well logs 140 to generate and/or update one or more descaling models 170. While the simulator 160 is shown at a well site, in some embodiments, the simulator 160 may be remote from a well site. In some embodiments, the simulator 160 is implemented as part of a software platform for the control system 114. The software platform may obtain data acquired by the drilling system 110 and logging system 112 as inputs, which may include multiple data types from multiple acoustic transmitters. The software platform may aggregate the data from these systems 110, 112 in real time for rapid analysis. In some embodiments, the control system 114, the logging system 112, and/or the simulator 160 may include a computer system that is similar to the computer 602 described below with regard to FIG. 6 and the accompanying description.

In some embodiments, a control system 114 may communicate commands to one or more well systems based on a descaling model (e.g., one of the descaling models 170). For example, the control system 114 may generate one or more control signals for positioning a workstring in the borehole 104 or a jetting tool at a downhole end for cleaning operations. Likewise, a simulator 160 may communicate replacement operations or scale treatment operations to one or more control systems based on one or more descaling models. For example, in response to a simulator 160 determining that a descaling treatment satisfies one or more predetermined criteria, a control system may implement the respective scale treatment. In contrast, where the simulator 160 determines that a scale treatment fails to satisfy a predetermined criterion, a control system may select a different scale treatment or a tubular replacement. Upon determining well tubular(s) that require replacement, casing or a production tubular may be removed from the borehole 104 and a new tubular inserted accordingly. Depending on the type of well tubular, a cementing operation may be performed that includes pumping cement slurry into the borehole 104 to displace existing well fluid and fill space between the well tubular and the untreated sides of the borehole 104. Thus, a control system may transmit commands to mixers and storage tanks for managing cement slurry (e.g., a mixture of various additives and cement) for a corresponding well intervention operation.

While FIG. 1 shows various configurations of components, other configurations may be used without departing from the scope of the disclosure. For example, various components in FIG. 1 may be combined to create a single component. As another example, the functionality performed by a single component may be performed by two or more components.

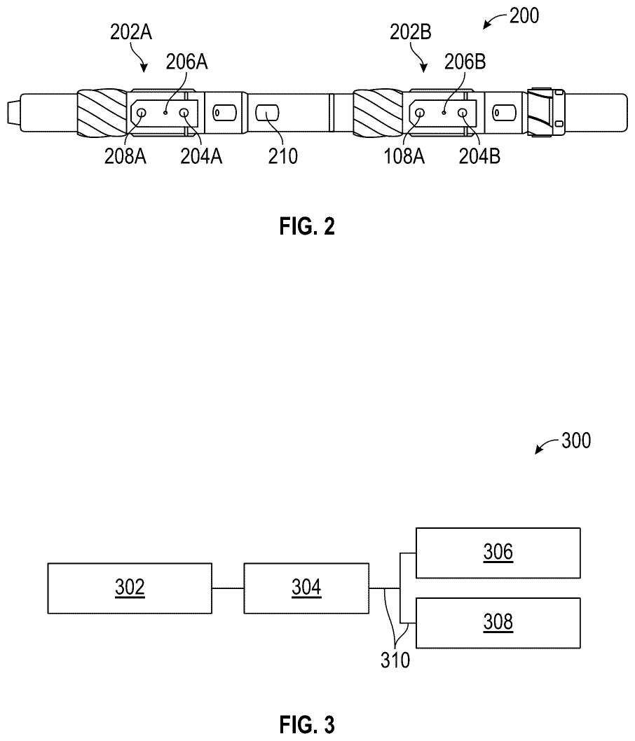

FIG. 2 shows a drillstring 200 of the drilling tool with a first acoustic caliper 202A and a second acoustic caliper 202B. The first acoustic caliper 202A includes an acoustic transmitter 204A, a near acoustic receiver 206A, and a far acoustic receiver 208A. Accordingly, the second acoustic caliper 202B includes an acoustic transmitter 204B, a near acoustic receiver 206B, and a far acoustic receiver 208B. The near acoustic receiver 206B is the same type of receiver as the far acoustic receiver, the only difference between the two being distance. The placement of both near and far acoustic receivers provides better data quality than just one or the other alone.

The acoustic transmitter 204A of the first acoustic caliper 202A transmits an acoustic pulse that is reflected on the borehole wall. The acoustic pulse is reflected from a borehole wall back to the near or far acoustic receiver 206A, 208A. The reflected acoustic pulse is received by either the near acoustic receiver 206A or the far acoustic receiver 208A. The second acoustic caliper 202B works similar to the first acoustic caliper 202A. The drillstring 200 contains two acoustic calipers for exactly measuring the distance from the drillstring to the borehole wall.

In some embodiments the acoustic pulse is a high-frequency pulse between 3 and 30 megahertz (MHz). In some embodiments, the acoustic pulse is an ultrasonic pulse including ultrasound with frequencies higher than 20 kilohertz (20,000 Hz) up to several gigahertz. The ultrasonic imaging of the borehole wall with a 3 GHz acoustic pulse produces an image with a resolution comparable to an optical image. The ultrasonic imaging uses frequencies of 2 megahertz and higher. The power density is less than 1 watt per square centimeter to avoid heating of the acoustic transmitter.

In some embodiments, the acoustic caliper is a smart acoustic caliper that generates a caliper log during a measurement-while-drilling (MWD) or logging-while-drilling (LWD). The caliper log may be printed as a continuous series of hole diameter values or radius values with respect to depth and accurate position of the acoustic caliper in the borehole. The smart acoustic caliper may include hardware for onboard calibration.

In some embodiments, a descaling model (e.g., one of the descaling models 170 of FIG. 1) is used to predict inner diameters of the borehole. In some embodiments, a descaling model uses acquired caliper logs to produce a virtual caliper log or synthetic caliper log. In some embodiments, a descaling model is a machine-learning model that is trained to predict caliper log values. Examples of machine-learning models include convolutional neural networks, deep neural networks, recurrent neural networks, support vector machines, decision trees, inductive learning models, deductive learning models, supervised learning models, etc. (see description of FIG. 6).

In some embodiments, the drilling tool includes several near acoustic receivers and the near acoustic receivers are distributed around the drillstring. Accordingly, the drilling tool may include several far acoustic receivers and the far acoustic receivers are distributed around the drillstring. In some embodiments, the near and/or far acoustic receivers may be distributed around the drillstring to detect acoustic signals coming from 360-degrees around the drillstring. Several near and/or far acoustic receivers distributed in 360-degrees around the drillstring provide accurate 3D images of the borehole wall and the borehole clearances. Deformations of the borehole wall, scale buildup on the borehole wall, and/or metal loss due to corrosion of the borehole may be visible in the 3D image.

Each of the first and second acoustic caliper 202A, 202B include a well positioning device (not shown in FIG. 2). As noted above, the well positioning device may be, collectively, the tools that are used to perform MWD, LWD, and GWD and are part of the bottom hole assembly (BHA) of the drillstring. In one or more embodiments, the well positioning devices determine the depth and accurate position of the acoustic calipers.

In some embodiments, the well positioning device is a MWD tool. The MWD tool may take directional surveys in real time. The MWD tool includes an accelerometer and/or a magnetometer to measure the inclination and/or azimuth of the borehole at a location. With a series of surveys and measurements of inclination and azimuth at depth intervals, i.e., anywhere from every 30 ft (10 m) to every 500 ft, the current depth of the acoustic receiver may be calculated. In other embodiments, the well positioning device is a well-logging tool for LWD.

The drilling tool further includes a PLC (not shown in FIG. 2). The PLC is capable of withstanding a rough drilling environment and is configured to process data and transfer it to the surface in real-time. The PLC includes its own rechargeable battery (not shown in FIG. 3) for transmitting data from the PLC to the logging system to the surface (the drilling cabin).

The PLC determines the time of flight between transmitting and receiving the acoustic pulse and determines a distance between an acoustic caliper and the borehole wall based on the time of flight of the acoustic pulse and the acoustic velocity of the fluid stored in the PLC. At the same time, the PLC receives the depth and accurate position of the acoustic caliper from the well positioning device of each acoustic caliper. Then, the PLC correlates the distance to the depth and position in data. Subsequently, the PLC refines the data by filtering outliers to optimize the data. Afterwards, the PLC processes the optimized data to develop an image of the borehole wall and transmits the image to the logging system to the surface.

In some embodiments, the PLC is a real-time computer (RTC) that processes data including the depth received from the well positioning device within a predetermined time period. The RTC is subject to a real-time constraint, such as a transmission time from measuring the distance and the depth to determining an image of the borehole wall. In some embodiments, the transmission time is every second, every 30 seconds, or every minute. The data is transmitted to the PLC and received by the PLC from the well positioning device. The PLC pulses the results continuously to the surface within the transmission time (e.g., 30 seconds to a few minutes). In some embodiments, the PLC is a hard real-time PLC that produces output results in response to input conditions within a limited time to avoid unintended operation. Therefore, the PLC experiences a total failure if the time limit/constraints are missed. In other embodiments, the PLC is a firm real-time PLC. The firm real-time PLC uses only the distances and depths where the time limit has been met. This degrades the quality of the borehole image depending on the number of distances and depths that miss the time limit. Yet in other embodiments, the PLC is a soft PLC. The usefulness of the measured distance and depth with a soft real-time PLC degrades after the time limit. Thus, a hard real-time PLC ensures that all time limits are met. In contrast, a soft real-time PLC meets a certain number of time limits.

In some embodiments, the PLC is a smart PLC that utilizes artificial intelligence (AI) to provide downhole measurements and 3D images. Therefore, the PLC includes an intelligent logic controller to process the data collected from the acoustic receivers and the well positioning device. The data is transferred to the logging system after processing the collected data in the PLC to enhance the accuracy of the data. The downhole image is obtained by processing the real-time data. The processing may be compared to actual values taken by, for example, a mechanical arm or other physical device. Time after time the algorithm (see below) for the data analysis may be improved using AI or machine-learning to train the model to produce a processed downhole image as close as possible to the actual downhole image taken by physical devices.

As used herein, AI includes machine learning algorithms and models. In some embodiments, the physical properties simulator includes hardware and/or software with functionality for generating and/or updating one or more machine-learning models to determine the physical properties of rocks. Examples of machine-learning models may include artificial neural networks, such as convolutional neural networks, deep neural networks, and recurrent neural networks. Machine-learning models may also include support vector machines, decision trees, inductive learning models, deductive learning models, supervised learning models, unsupervised learning models, reinforcement learning models, etc. In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network.

In some embodiments, two or more different types of machine-learning models are integrated into a single machine-learning architecture, e.g., a machine-learning model may include support vector machines and neural networks. In some embodiments, the physical properties simulator may generate augmented data or synthetic data to produce a large amount of interpreted data for training a particular model. In some embodiments, various types of machine learning algorithms may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model.

With respect to artificial neural networks, for example, an artificial neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the artificial neural network. Likewise, these weighted data inputs may be summed such that this sum is communicated through a neuron's activation function to other hidden layers within the artificial neural network. As such, the activation function may determine whether and to what extent an output of a neuron progresses to other neurons where the output may be weighted again for use as an input to the next hidden layer.

The well positioning device is configured to take surveys of the wellbore at various depths. At each survey an inclination and azimuth along with measured depth from the drill-string tally (i.e., a list with details of tubulars prepared for running in the wellbore) is recorded. Each survey provides 3D coordinates (X, Y, Z) or (Easting, Northing, Total vertical depth, TVD) as data. The data is then received by the PLC. The PLC is programmed to process the data and send it to the surface, i.e., the drilling cabin, as a binary code. The binary code is translated into a hole image. As the position of the drillstring is available as 3D coordinates X, Y, Z, it is possible to determine the well direction. Furthermore, the PLC is able to correlate the acoustic data to its registered coordinates, which allows for precise measurement of the hole dimensions vs. the registered coordinates.

The placement of the drilling tool downhole and between the two acoustic receivers and above the well positioning device provides optimized media for the PLC to receive the raw data from the acoustic receivers and send the processed data to the logging system to the surface. Each measurement is taken at the direction and position in the borehole to reflect the registered coordinate indicating the destination of the measured borehole diameter at the tool position. This results in an accurate real-time image of the drilling tool without averaging the diameter. FIG. 3 shows a schematic view of the drilling tool 300, according to FIG. 2. The drilling tool 300 includes a logging system 302 that may be disposed in the drilling cabin referred to as “surface” above, or on the Earth's surface, a PLC 304, acoustic receivers (near and far) 306, and well positioning devices 308. FIG. 3 depicts the data collecting, processing and transmission route in real-time.

The logging system 302 is connected to the PLC 304, and the PLC 304 is connected to the acoustic receivers (near and far) and to the well positioning devices 308. In one or more embodiments, the acoustic receivers 306 and the well positioning devices 308 are connected to the PLC 304 by a fiber optic cable 310.

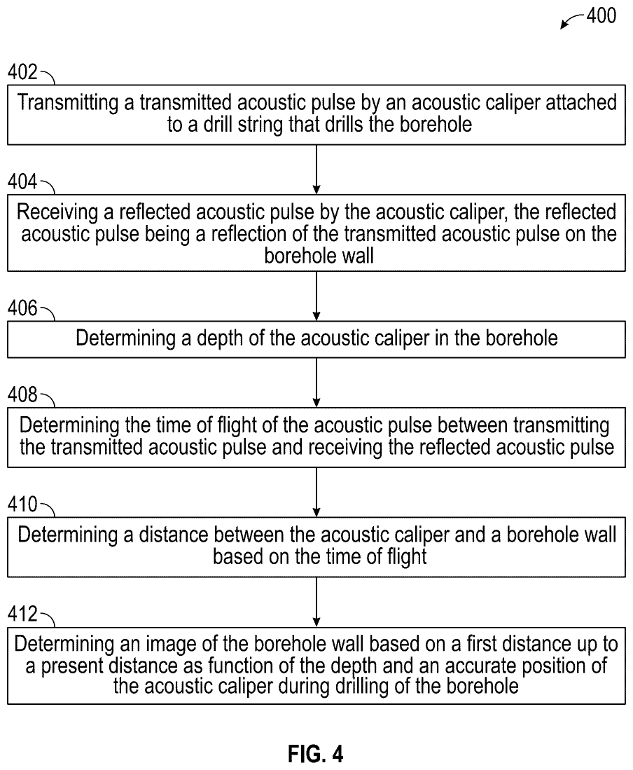

FIG. 4 shows a flowchart 400 of the method steps for determining a real-time image of a borehole wall during drilling of a borehole. Specifically, once the drillstring (i.e., the BHA and drill bit, particularly) starts drilling the borehole and the borehole is filled with a drilling fluid, each of the following steps 402 to 412 is repeated until the borehole is drilled to the end.

In Step 402, a transmitted acoustic pulse is transmitted by an acoustic caliper attached to a drillstring that drills the borehole. The transmitter transmits the transmitted acoustic pulse perpendicular to the drillstring. The transmitted acoustic pulse propagates through the drilling fluid to the borehole wall.

In Step 404, a reflected acoustic pulse is received by the acoustic caliper. The reflected acoustic pulse is a reflection of the transmitted acoustic pulse on the borehole wall. More specifically, once the transmitted acoustic caliper reaches the borehole wall, the transmitted acoustic pulse is reflected on the borehole wall and the reflection of the transmitted acoustic pulse (reflected acoustic pulse) propagates through the drilling fluid back to the acoustic caliper where the reflected acoustic pulse is received by a receiver of the acoustic caliper.

In a next Step 406, a depth of the acoustic caliper in the borehole is determined. The depth of the acoustic caliper in the borehole may be determined by a well positioning device capable of performing MWD, LWD, GWD, etc., and attached to the drillstring as described above. The depth is determined by the drillstring tally. The well positioning devices determine the inclination and azimuth direction of the well.

In Step 408, the time of flight of the acoustic pulse between transmitting the transmitted acoustic pulse and receiving the reflected acoustic pulse is determined. In one or more embodiments, the time of flight is determined by counting the shortest time from transmitting the transmitted acoustic pulse by the acoustic transmitter until the very first reflection of the reflected acoustic pulse is received by the receiver of the acoustic caliper. The counting is done by the PLC.

In Step 410, a distance between the acoustic caliper and a borehole wall is determined based on the time of flight. Specifically, once the time of flight is determined, the distance is determined by multiplying the velocity of the acoustic pulse in the drilling fluid with the time of flight: d=ν·t, where d is the distance, ν is the velocity of the acoustic pulse in the drilling fluid, and t is time of flight.

In step 412, an image of the borehole wall is determined during drilling of the borehole based on the distance as function of the depth and an accurate position of the acoustic caliper during drilling of the borehole.

Once the drillstring starts drilling the borehole, the PLC starts measuring the distance from the acoustic caliper to the borehole wall. While the drillstring rotates, the acoustic caliper rotates with the drillstring and the PLC measures the distances from the acoustic caliper to the borehole wall. During the drilling of the borehole, an accurate position of the acoustic caliper around the drillstring is also determined by the acoustic caliper and the PLC. The depth and the accurate position are used by the PLC to determine an image of the borehole wall surrounding the acoustic caliper. While the drillstring drills its way through the borehole, the acoustic caliper determines the images of the borehole wall surrounding the acoustic caliper. During the drilling of the borehole, the PLC merges the images of the borehole walls surrounding the acoustic caliper and determines a complete image of the borehole wall drilled so far by the drillstring. The complete image of the borehole wall is then transmitted to the logging system to the surface.

This image of the borehole wall may be used to make adjustments, in real-time, while drilling the remainder of the borehole, or may be used to continue drilling the borehole if no adjustments are necessary. An image of what is upcoming as the borehole is being drilled may be used to intelligently drill the borehole.

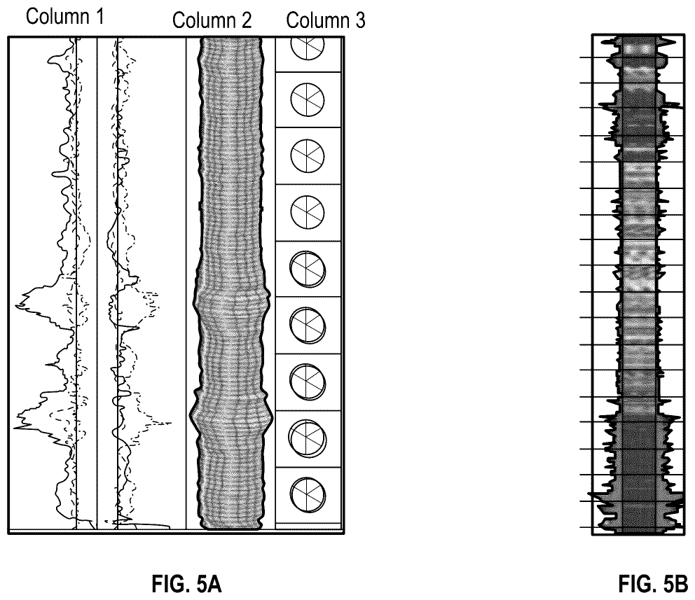

FIG. 5A shows an image of a borehole in accordance with one or more embodiments disclosed herein. This image may be computer-generated based on the measurements made by the acoustic calipers at various depths and accurate positions, as described above. Column 1 in FIG. 5A shows the distance from the drillstring to the borehole wall as function of the depth and accurate position of the acoustic caliper in the borehole, measured by three different acoustic calipers along the drillstring. Column 2 shows an image of the borehole walls based on an average of the distances shown in column 1.

Column 3 shows the variation of the diameter of the borehole as the drillstring drills to the bottom of the borehole. In other words, the eccentricity of the cross section of the image of column 2 is shown in column 3. The eccentricity shows how much the cross section deviates from a circle.

FIG. 5B shows hole images taken during drilling in real-time where the values were processed by the PLC. Thus, FIG. 5A shows real examples of hole imaging taken by wireline, while FIG. 5B shows the same results obtained while drilling and in real-time.

Embodiments of the smart PLC utilizing AI may be implemented on a computer system. FIG. 6 is a block diagram of a computer 602 used to provide computational functionalities associated with described algorithms, methods, functions, processes, flows, and procedures as described in the instant disclosure, according to an implementation. The illustrated computer 602 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 602 may include a computer that includes an input device, such as a keypad, keyboard, touch screen, or other device that can accept user information, and an output device that conveys information associated with the operation of the computer 602, including digital data, visual, or audio information (or a combination of information), or a GUI.

The computer 602 can serve in a role as a client, network component, a server, a database or other persistency, or any other component (or a combination of roles) of a computer system for performing the subject matter described in the instant disclosure. The illustrated computer 602 is communicably coupled with a network 630. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, business intelligence (BI) server, or other server (or a combination of servers).

The computer 602 can receive requests over network 630 from a client application (for example, executing on another computer 602) and responding to the received requests by processing the said requests in an appropriate software application. In addition, requests may also be sent to the computer 602 from internal users (for example, from a command console or by other appropriate access method), external or third-parties, other automated applications, as well as any other appropriate entities, individuals, systems, or computers.

Each of the components of the computer 602 can communicate using a system bus 603. In some implementations, any or all of the components of the computer 602, both hardware or software (or a combination of hardware and software), may interface with each other or the interface 604 (or a combination of both) over the system bus 603 using an application programming interface (API) 612 or a service layer 613 (or a combination of the API 612 and service layer 613. The API 612 may include specifications for routines, data structures, and object classes. The API 612 may be either computer-language independent or dependent and refer to a complete interface, a single function, or even a set of APIs. The service layer 613 provides software services to the computer 602 or other components (whether or not illustrated) that are communicably coupled to the computer 602. The functionality of the computer 602 may be accessible for all service consumers using this service layer. Software services, such as those provided by the service layer 613, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 or the service layer 613 as stand-alone components in relation to other components of the computer 602 or other components (whether or not illustrated) that are communicably coupled to the computer 602. Moreover, any or all parts of the API 612 or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602. The interface 604 is used by the computer 602 for communicating with other systems in a distributed environment that are connected to the network 630. Generally, the interface 604 includes logic encoded in software or hardware (or a combination of software and hardware) and operable to communicate with the network 630. More specifically, the interface 604 may include software supporting one or more communication protocols associated with communications such that the network 630 or interface's hardware is operable to communicate physical signals within and outside of the illustrated computer 602.

The computer 602 includes at least one computer processor 605. Although illustrated as a single computer processor 605 in FIG. 6, two or more processors may be used according to particular needs, desires, or particular implementations of the computer 602. Generally, the computer processor 605 executes instructions and manipulates data to perform the operations of the computer 602 and any algorithms, methods, functions, processes, flows, and procedures as described in the instant disclosure.

The computer 602 also includes a memory 606 that holds data for the computer 602 or other components (or a combination of both) that can be connected to the network 630. For example, memory 606 can be a database storing data consistent with this disclosure. Although illustrated as a single memory 606 in FIG. 6, two or more memories may be used according to particular needs, desires, or particular implementations of the computer 602 and the described functionality. While memory 606 is illustrated as an integral component of the computer 602, in alternative implementations, memory 606 can be external to the computer 602.

The application 607 is an algorithmic software engine providing functionality according to particular needs, desires, or particular implementations of the computer 602, particularly with respect to functionality described in this disclosure. For example, application 607 can serve as one or more components, modules, applications, etc. Further, although illustrated as a single application 607, the application 607 may be implemented as multiple applications 607 on the computer 602. In addition, although illustrated as integral to the computer 602, in alternative implementations, the application 607 can be external to the computer 602.

There may be any number of computers 602 associated with, or external to, a computer system containing computer 602, each computer 602 communicating over network 630. Further, the term “client,” “user,” and other appropriate terminology may be used interchangeably as appropriate without departing from the scope of this disclosure. Moreover, this disclosure contemplates that many users may use one computer 602, or that one user may use multiple computers 602.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A drilling tool for determining a real-time image of a borehole during drilling of the borehole, comprising:
a drillstring that drills a borehole;
an acoustic caliper attached to the drillstring, wherein the acoustic caliper comprises:
an acoustic transmitter that transmits a transmitted acoustic pulse, and
an acoustic receiver that receives a reflected acoustic pulse, wherein the reflected acoustic pulse is a reflection of the transmitted acoustic pulse on a borehole wall;
a well positioning device that determines a depth and an accurate position of the acoustic caliper in the borehole, and
a Programmable Logic Controller (PLC) configured to:
determine, in real-time, the time of flight of the acoustic pulse between transmitting the transmitted acoustic pulse and receiving the reflected acoustic pulse of the acoustic caliper,
determine, in real-time, a distance between the acoustic caliper and a borehole wall based on the time of flight, and
determine, in real-time, an image of the borehole wall during drilling of the borehole based on the distance as function of the depth and the accurate position.

2. The drilling tool according to claim 1, wherein the acoustic receiver comprises a near acoustic receiver and a far acoustic receiver.

3. The drilling tool according to claim 2, wherein the acoustic caliper comprises several near acoustic receivers, and the near acoustic receivers are disposed around the drillstring.

4. The drilling tool according to claim 2, wherein the acoustic caliper comprises several far acoustic receivers, and the far acoustic receivers are disposed around the drillstring.

5. The drilling tool according to claim 1, wherein a fiber optic cable connects the PLC to the acoustic receiver.

6. The drilling tool according to claim 1, wherein the PLC is a smart PLC that utilizes artificial intelligence (AI) to compare an actual image of the borehole wall taken by a physical device with the image of the borehole wall processed by the PLC and obtained during drilling.

7. The drilling tool of claim 6, wherein the AI comprises a machine learning model that is trained to improve the processed image to obtain a 3D image of the borehole wall that is more accurate when compared to the actual image.

8. The drilling tool according to claim 1, wherein the acoustic pulse is a high-frequency pulse between 3 and 30 megahertz (MHz).

9. The drilling tool according to claim 1, wherein the acoustic pulse is an ultrasonic pulse including ultrasound with frequencies higher than 20 kilohertz (20,000 Hz) up to several gigahertz.

10. The drilling tool according to claim 1, wherein the PLC is a real-time computer (RTC) that processes data including the depth received from the well positioning device within a predetermined time period.

11. The drilling tool according to claim 1, wherein the well positioning device is a collection of tools for performing measurement while drilling, logging while drilling and gyro-measurement while drilling.

12. A method for determining a real-time image of a borehole wall during drilling of a borehole, the method being performed during drilling of the borehole and comprising:
transmitting a transmitted acoustic pulse by an acoustic caliper attached to a drillstring that drills the borehole;
receiving a reflected acoustic pulse by the acoustic caliper, wherein the reflected acoustic pulse is a reflection of the transmitted acoustic pulse on the borehole wall;
determining a depth of the acoustic caliper in the borehole;
determining a time of flight of the acoustic pulse between transmitting the transmitted acoustic pulse and receiving the reflected acoustic pulse;
determining a distance between the acoustic caliper and a borehole wall based on the time of flight; and
determining an image of the borehole wall during drilling of the borehole based on the distance as function of the depth and an accurate position of the acoustic caliper during drilling of the borehole.

13. The method of claim 12, wherein the transmitted acoustic pulse is transmitted perpendicular to the drillstring.

14. The method of claim 12, wherein the time of flight is determined by counting a shortest time from transmitting the transmitted acoustic pulse by an acoustic transmitter until a very first reflection of the reflected acoustic pulse is received by the receiver of the acoustic caliper.

15. The method of claim 14, wherein a Programmable Logic Controller (PLC) counts the shortest time.

16. The method of claim 12, wherein the distance between the acoustic caliper and a borehole wall is determined by multiplying a velocity of the acoustic pulse in a drilling fluid used for drilling the borehole with the time of flight.

17. The method of claim 15, further comprising: using artificial intelligence (AI) to compare an actual image of the borehole wall taken by a mechanical arm with the image of the borehole wall obtained from the PLC.

18. The method of claim 17, wherein the AI comprises a machine learning model that is trained to improve the obtained image to obtain a 3D image of the borehole wall that is more accurate when compared to the actual image.

19. The method of claim 12, further comprising: sending data comprising the distance and an according depth and the accurate position as a binary code to a directional driller cabin where the binary code is translated to the image of the borehole wall.
